(19) United States
(12) Patent Application Publication
(10) Pub. No.: US 2003/0064718 A1
(43) Pub. Date: Apr. 3, 2003

(54) Selective communication in a wireless network based on peer-to-peer signal quality

(76) Inventors: Robert E. Haines, Boise, ID (US); Paul L. Jeran, Boise, ID (US); Travis J. Parry, Boise, ID (US); Gary L. Holland, Boise, ID (US)

Correspondence Address: HEWLETT-PACKARD COMPANY, Intellectual Property Administration, P.O. Box 272400, Fort Collins, CO, 80572-2400, US

(21) Appl. No.: 09/966,407

(22) Filed: Sep. 28, 2001

(51) Int. Cl. H04Q 7/20

(52) U.S. Cl. 455/423; 455/67.3

(57) ABSTRACT

Methods and apparatus for identifying and prioritizing wireless network devices are useful for selectively establishing communications based on the prioritization. Signal strength in a wireless network is indicative of a distance between a transmitting device and a receiving device. The strongest signal can be presumed to be emanating from the nearest device. Other signal qualities can be indicative of a presumed quality of service. By combining signal quality information with supplemental information concerning the devices, the various embodiments facilitate identifying those devices that match some selection criteria and prioritizing those matching devices based on the signal quality information. An example is to identify the wireless network device having desired characteristics that is nearest a network user.

### TECHNICAL FIELD OF THE INVENTION

The present invention relates generally to selectively establishing communication in a wireless network, and in particular to selectively establishing communication with a wireless network device in part based on a quality of the signals received from one or more wireless network devices within a wireless network.

### BACKGROUND OF THE INVENTION

As networks of computing devices and peripherals become more complex and dynamic, it becomes increasingly important for the network structure to be flexible and to be easily updated. To address this challenge, wireless networks have become increasingly popular. Because device additions to a wireless network do not require the addition or rerouting of physical cabling, they are generally more flexible and easily updated than are wired networks. Wireless networks further have the advantage of being able to accommodate transient or mobile users.

One dilemma a network user may face is determining the physical location of a computer peripheral or other network device. As an example, a wireless network user may want to print out a color document from their palmtop computer. The user may want to locate a nearby color printer. While the operating system may be able to provide a list of suitable imaging devices along with textual descriptions of their location, this may not be helpful to the user if they are unfamiliar with the building or complex where the network is located. The user may prefer to simply know what suitable device is nearest the user or is preferred based on some other quality.

For the reasons stated above, and for other reasons stated below that will become apparent to those skilled in the art upon reading and understanding the present specification, there is a need in the art for alternative methods for identifying a preferred wireless network device relative to a reference point.

### SUMMARY

Methods and apparatus for identifying and prioritizing wireless network devices are described herein for selectively establishing communications based on the prioritization. Signal strength in a wireless network is indicative of a distance between a transmitting device and a receiving device. The strongest signal can be presumed to be emanating from the nearest device. Other signal qualities can be indicative of a presumed quality of service. By combining signal quality information with supplemental information concerning the devices, the various embodiments facilitate identifying those devices that match some selection criteria and prioritizing those matching devices based on the signal quality information. An example is to identify the wireless network device matching the selection criteria that is nearest a reference point.

For one embodiment, the invention provides a method of identifying and prioritizing wireless network devices. The method includes detecting a signal from one or more wireless network devices, wherein each signal has at least one signal quality. The method further includes identifying each of the detected wireless network devices that match a selection criteria, associating the at least one signal quality with its respective wireless network device for each wireless network device that matches the selection criteria, and prioritizing the wireless network devices that match the selection criteria based on their associated at least one signal quality.

For another embodiment, the invention provides a method of identifying and prioritizing wireless network devices. The method includes, for one or more wireless network devices, detecting a wireless network device, wherein the wireless network device transmits a signal having a first signal quality. The method further includes querying the wireless network device to determine whether it is of a desired type, querying the wireless network device to determine whether is has a desired status, and associating the first signal quality with the wireless network device when it is of the desired type and it has the desired status. The method still further includes generating a list of wireless network devices that are of the desired type and have the desired status, and prioritizing the list of wireless network devices based at least on their associated first signal quality.

For yet another embodiment, the invention provides a computer-usable medium having computer-readable instructions stored thereon capable of causing a processor to perform a method. The method includes receiving a signal from a transmitting wireless network device, wherein the signal has at least one signal quality. The method further includes obtaining supplemental information from the wireless network device, associating the at least one signal quality with the wireless network device and its supplemental information and comparing the supplemental information with a selection criteria to determine whether the wireless network device matches the selection criteria. If the wireless network device matches the selection criteria, the method further includes prioritizing the wireless network device against other wireless network devices matching the selection criteria. The prioritization is based on at least one signal quality.

Further embodiments of the invention include apparatus and methods of varying scope.

### BRIEF DESCRIPTION OF THE DRAWINGS

FIG. 1 is a schematic of a typical wireless network containing one or more wireless gateways and one or more other network devices.

FIG. 2 is a schematic of a wireless network showing curves of estimated distance in accordance with an embodiment of the invention.

FIGS. 3A-3B are flowcharts of methods of identifying and prioritizing wireless network devices in accordance with embodiments of the invention.

FIG. 4 is a schematic of a wireless network having at least one network device in accordance with an embodiment of the invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

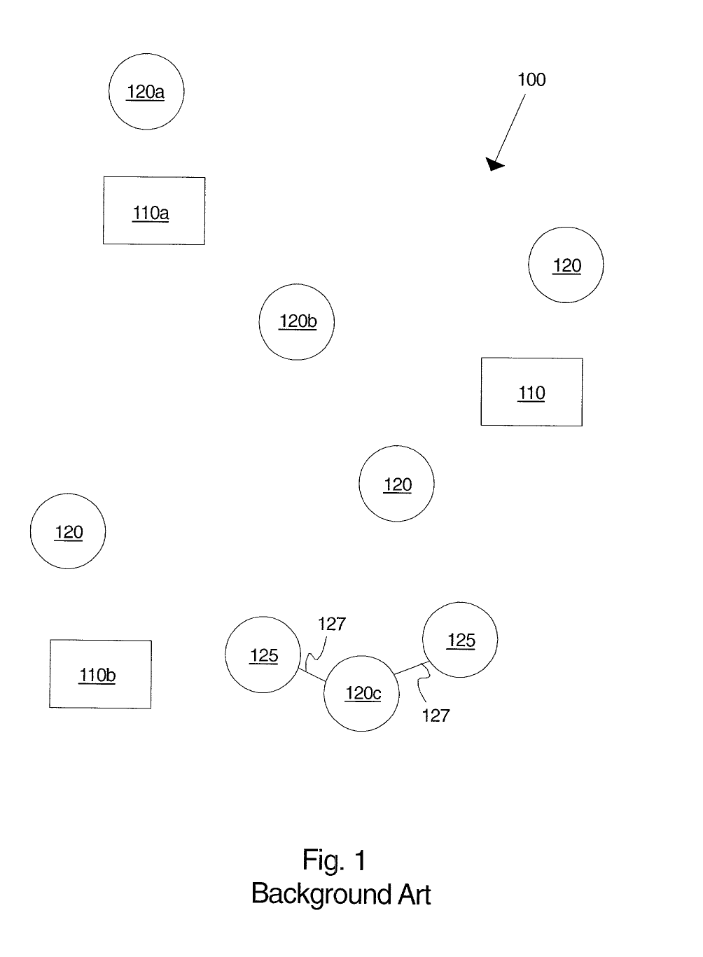

Certain embodiments provide methods of determining an expected location of a network device, relative to a reference network device, based on a signal strength of the network device received at the reference device in a wireless network. Additional embodiments provides methods of prioritizing network devices based on other received signal qualities. FIG. 1 is a schematic of a typical wireless network 100 containing one or more wireless gateways 110 and one or more other network devices 120. The gateways are access points to the network for various client devices. The network devices 120 communicate with one or more of the gateways 110 using some form of wireless communication. Wireless communications include radio frequency (RF) communications, infrared (IR) communications, microwave communications and other techniques for communicating between devices without the need for a physical connection. Some examples of the network devices 120 include imaging devices (e.g., printers, facsimile machines, plotters and other devices for producing an image, whether single or multi-function devices), servers, workstations and storage devices (e.g., magnetic tape storage, magnetic disk storage, optical media storage and dynamic or non-volatile memory, whether permanent or removable).

The wireless gateways 110 act as a relay within the wireless network 100 to facilitate communication between two network devices 120 that are not within range of each other. However, the wireless network devices 120 are capable of direct, or peer-to-peer, communications between each other, albeit at a reduced communication range. As an example, wireless network devices 120a and 120b may be near enough to communicate directly. However, communication from wireless network device 120a to wireless network device 120c may require a relay from wireless network device 120a to wireless gateway 110a to wireless gateway 110b to wireless network device 120c.

One or more of the wireless network devices 120 may also communicate with wired network devices. As an example, the network device 120c may be a server, bridge, router or other wireless device on the wireless network 100 used to connect one or more wired network devices 125 to the wireless network 100 through physical wired connections 127. As an example, the network device 120c could be a computer workstation coupled to two imaging devices, such as a local laser printer and a local color printer. The wired connections 127 may be such physical connections as a parallel port connection to the workstation, a serial port connection to the workstation, a universal serial bus (USB) connection to the workstation and other cabled or direct-wired connections.

On a wired network, it is generally impossible to determine the relative distances between network devices based on information generated by the member network devices. While a time lag or propagation delay between sending and receiving a packet of information can give an indication of how far a signal traveled, the path may not be direct. As an example, two receiving devices could be pinged by a sending device. A propagation delay of one unit of time from the sending device to a first receiving device and three units of time from the sending device to a second receiving device may mean that the path between the sending device and the first receiving device is one-third the length of the path between the sending device and the second receiving device. However, the second receiving device may be located physically closer to the sending device, but merely have a more circuitous path from the sending device than does the first receiving device. Accordingly, the time lag cannot be used to determine relative distance between network devices. A network user may also use the number of router “hops” to determine whether network devices are contained in the same subnetwork, i.e., crossing a router indicates that a device is on a different subnetwork. However, as with propagation delay, a receiving device several subnetworks away may be physically adjacent to the sending device.

Contrarily, in a wireless network 100, data travels between wireless devices substantially in a straight line. It is known that signal strength of a wireless transmission is generally inversely proportional to the square of the distance. That is, a received signal strength at distance x from a sending device is approximately 1/x² the strength of the originating signal. Thus, if one knows the strength of the transmitted signal, the distance traveled may be calculated from the received signal strength.

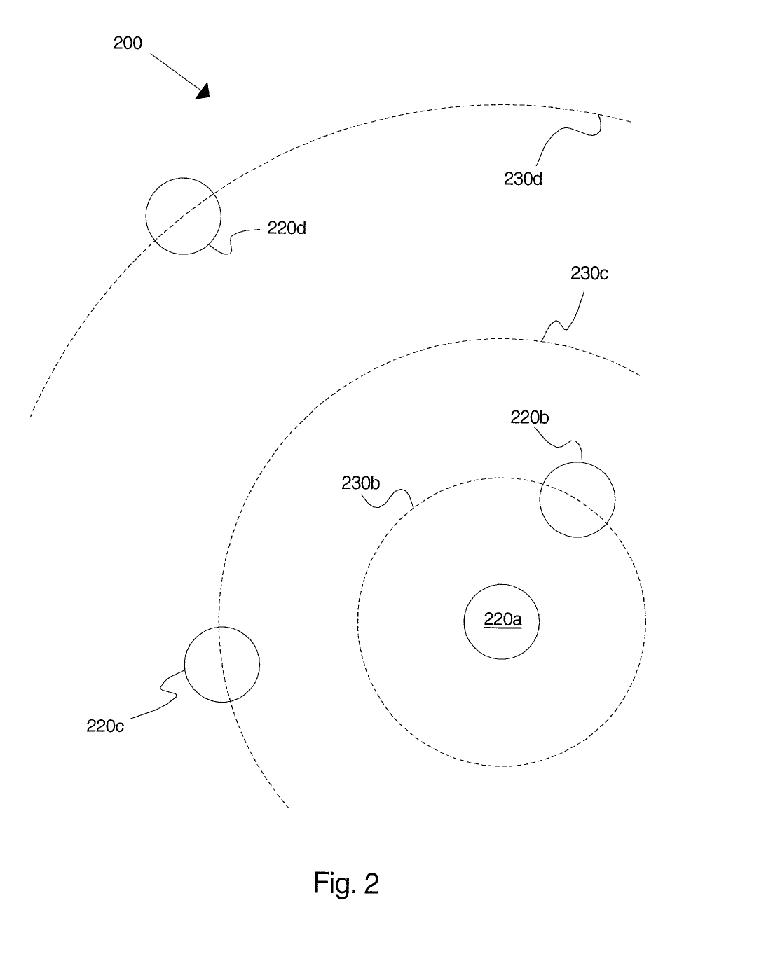

FIG. 2 is a schematic of a wireless network 200 containing one or more wireless network devices 220, such as wireless network devices 220a, 220b, 220c and 220d. The network device 220a receives or detects wireless communications from the network devices 220b, 220c and 220d that are within its range of reception. The network device 220a further detects a quality of the received signal, such as a signal strength. Additional or alternate examples of a signal quality include signal noise and a signal-to-noise ratio. While signal qualities may be detected and gathered in a variety of manners, wireless network client managers often provide this information as a utility or troubleshooting feature. An example of a client manager providing this information is the ORiNOCO™ Client Manager available from Lucent Technologies, Murray Hill, N.J., USA.

Using signal strength as the signal quality, relative distances to the transmitting devices can be determined as described earlier. Lower signal strength indicates that the transmitting device is more distant. Of course, this presumes that each transmitting device transmits at approximately the same power level. Thus, it is desirable that the wireless network devices 220 of the wireless network 200 each transmit using approximately the same power level. Alternatively, the transmission level of each device can be determined and associated with the device in a database, a table or some other data structure for use in determining estimated distance.

The estimated distance can be represented mathematically as some form of closed curve such that the transmitting device is expected to be at some point on the curve surrounding the receiving device. For an omni-directional receiver, the closed curve would be circular in a two-dimensional system and spherical in a three-dimensional system. For purposes herein, a two-dimensional system implies that the receiving devices and the transmitting device all reside in substantially the same plane, such as a floor of an office building. Similarly, a three-dimensional system implies that the receiving devices and the transmitting device reside in different planes, such as multiple floors of the office building.

An example of a two-dimensional system using an omni-directional receiver at network device 220a is shown in FIG. 2 with the arcs 230b, 230c and 230d representing portions of the closed curves associated with the wireless network devices 220b, 220c and 220d, respectively. For directional receivers, the shapes of the closed curves can be determined from the characteristics of the receivers. For example, a cardioid receiver may result in a curve of the estimated distance that is generally heart-shaped. The various embodiments will be described using the assumption of an omni-directional receiver, but the extension to more complex curves involves merely the substitution of the appropriate equation for the estimated distance.

The network device 220b is expected to be located somewhere on the curve 230b, the network device 220c is expected to be located somewhere on the curve 230c, and the network device 220d is expected to be located somewhere on the curve 230d. It is noted that because the network device 220a cannot determine from which direction the signals are received, the actual location of the transmitting devices is not determinable merely from the signal strength. From the curves 230b, 230c and 230d, it can be inferred that the network device 220b is nearer to the network device 220a than are the network devices 220c or 220d.

It is conceivable that one or more of the transmitting devices will be so close to the receiving device that the received signal will be saturated. In such circumstances, each received signal can be attenuated until one or none of the relevant signals is saturated. A relevant signal is a signal received from a device that matches a selection criteria defined by the user. Because non-matching devices are not of interest, whether their signals are saturated is likewise irrelevant.

If estimated distance is desired, the calculated distance must be correspondingly adjusted downward, such as by the square root of the attenuation. For example, if the received signal is attenuated using a gain factor of 0.8 and an omni-directional receiver, the distance estimated from this attenuated signal should be multiplied by the square root of 0.8 for use in estimating the expected distance of the transmitting device. However, the various embodiments can be performed without the need to estimate distance.

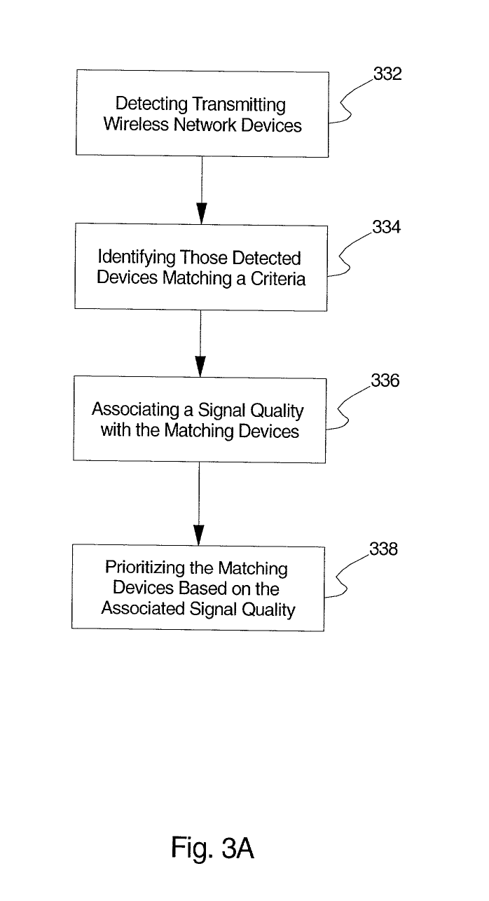

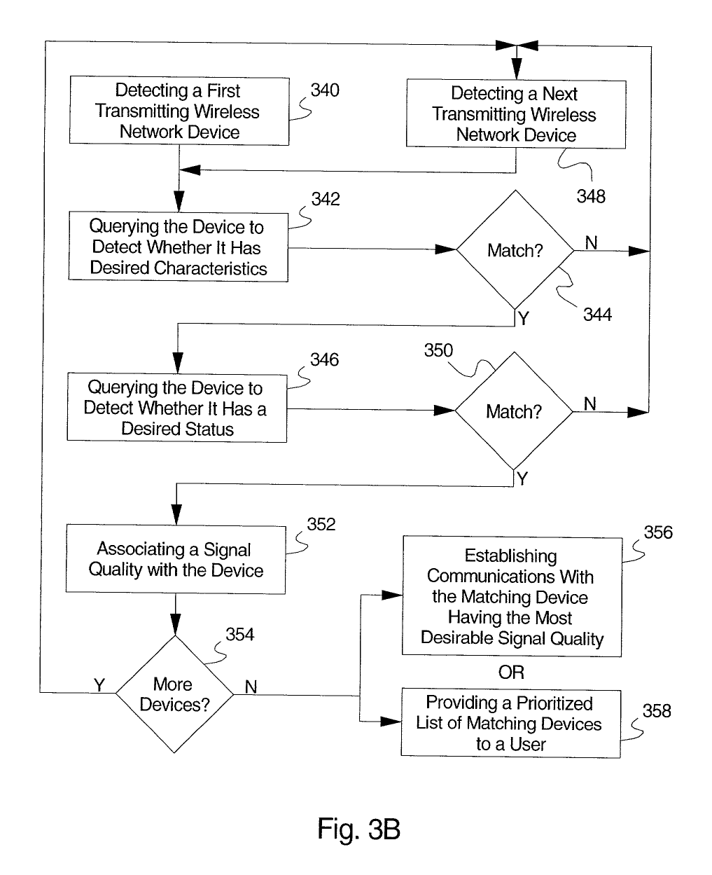

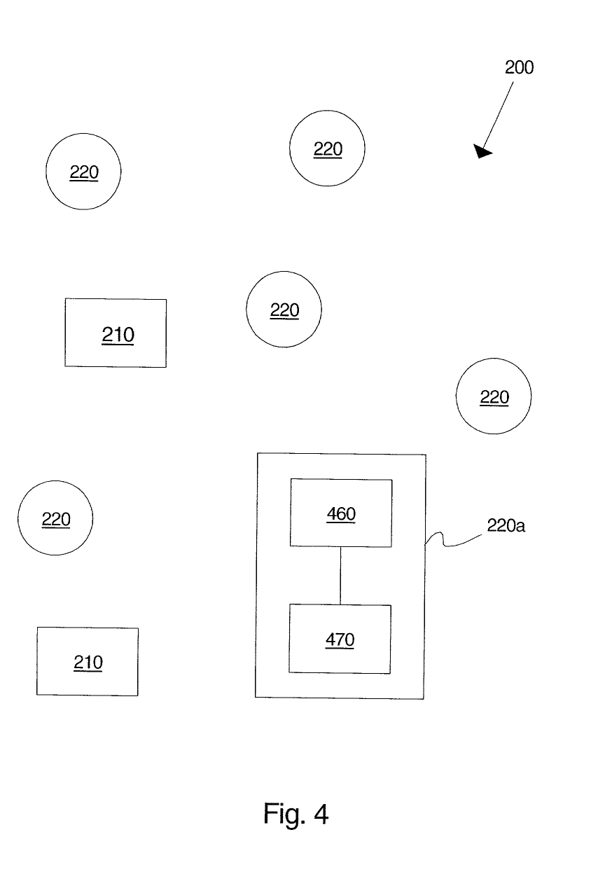

FIG. 3A is a flowchart for a method of prioritizing from among the various network devices within a range of reception for a reference device in accordance with an embodiment of the invention. Wireless network devices within the range of reception of a reference network device are detected at box 332. For one embodiment, such detection includes detecting transmissions at the reference network device. For another embodiment, such detection includes pinging or otherwise broadcasting a request for a response from any wireless network device within range of the reference network device.

Of the detected network devices, those matching a defined selection criteria are identified at box 334. For example, each detected device may be queried for such supplemental information as device type, device name, device features or capabilities, device status, past device performance (including indicators of reliability, strength, uptime, etc.), available consumables, transaction costs (including average cost per transaction, per byte, per page, etc.), device permissions (including indicators of which users or groups of users have appropriate accounts or authentication), etc. For those matching devices, the quality of the signals received at the reference network device are associated with their respective devices, such as in a data structure, at box 336. The set of matching devices can then be prioritized based on the associated signal quality at box 338.

Prioritization can be based on any signal quality. For example, the set of matching devices can be prioritized based on signal strength if it is desired to establish communications with a device that is expected to be nearest the reference device. The set of matching devices can alternatively be prioritized based on signal noise if it is desired to establish communications with a device whose signal has the least amount of noise. The set of matching devices can further be prioritized based on a signal-to-noise ratio if it is desired to establish communications with a device whose signal is expected to be less prone to data loss. The prioritization can include more than one sorting criteria. For example, the prioritization can be sorted first by signal strength to indicate those devices within an expected range of distances, and then sorted by signal noise. This could be used, for example, to select a device having the cleanest signal from a set of devices that are within a desired maximum distance from the user. For another embodiment, the prioritization can be sorted by a first signal quality and select devices within the prioritization list may be highlighted based on a second signal quality being above or below some threshold. This could be used, for example, to provide the user with a list of devices matching their search criteria in an order of relative distance from the user, with devices having a signal-to-noise ratio above some threshold being highlighted on the list.

The prioritization can be used as part of an automated process to establish communications with a matching device. For example, the reference network device can automatically establish communication with the network device that matches the defined selection criteria and has the most desirable signal quality or qualities. Consider a user with a palmtop computer who desires to print a color document at the nearest color imaging device. The user defines the selection criteria to be a color imaging device that is on-line and available. The network devices within the range of the palmtop computer are detected and evaluated against the selection criteria. The signal strength of those devices matching the selection criteria are evaluated to determine the matching device having the highest signal level. The color document is then printed to the matching device having the highest signal level without further user input. Of course, the reference network device, in this case the palmtop computer, should give an indication as to which imaging device was chosen for sending the color document.

Alternatively, the prioritization can be used as part of a manual process to establish communications with a matching device. To continue with the previous example, instead of automatically printing the color document, the prioritized list may be presented to the user for a user selection of the desired imaging device. In response to the user selection, the color document is then printed to the selected imaging device.

FIG. 3B is a flowchart for a method of prioritizing from among the various network devices within a range of reception for a reference network device in accordance with another embodiment of the invention. A first transmitting wireless network device is detected at the reference network device at box 340. The first wireless transmitting network device may be transmitting continuously, periodically or in response to a request from the reference network device. A detected device is queried at box 342 to determine whether it has the desired device characteristics. Determining whether a device has the desired characteristics can include determining whether the device has the proper capabilities for the desired task. If the device characteristics are correct at box 344, control continues at box 346. If the device characteristics are not correct at box 344, control transfers to box 348 where a next transmitting wireless network device is detected at the reference network device.

At box 346, a detected device is queried to determine whether it has a desired status. Status can include whether a device is on-line or off-line, whether the device is registering an error, whether the device has available consumables, etc. If the status is correct at box 350, control continues at box 352. If the status of the device is not correct at box 350, control transfers to box 348 where a next transmitting wireless network device is detected.

At box 352, a signal quality of the detected device having the correct characteristics and status is associated with the device. If there are additional devices at box 354, control is transferred to box 348 for further detection. If there are no more devices at box 354 or the reference device fails to detect any further transmitting devices, communications can be established with the device having the correct type and status that has the most desirable signal quality, such as the highest signal strength, at box 356. Alternatively, a prioritized list of matching devices may be presented to a user of the reference network device at box 358 to permit user selection of the desired matching device.

The methods of the various embodiments are suited to be performed by computer processors in response to instructions in either software, firmware or hardware. These computer-readable instructions are stored on a computer-usable medium and are adapted to cause the processor to perform the methods. In a hardware solution, the instructions are hard coded as part of a processor, e.g., an application-specific integrated circuit (ASIC) chip, to perform the methods of one or more of the embodiments. In a software or firmware solution, the instructions are stored for retrieval by the processor. Some additional examples of computer-usable media include static or dynamic random access memory (SRAM or DRAM), read-only memory (ROM), electrically-erasable programmable ROM (EEPROM), magnetic media and optical media, whether permanent or removable.

FIG. 5 is a schematic of a wireless network 200 having one or more wireless network devices 220 and optionally having one or more wireless gateways 210. The wireless network 200 may have one or more wired network devices (not shown in FIG. 5) coupled to one or more of its wireless network devices 220. For purposes of selecting a desired network device in accordance with the various embodiments, these wired network devices can be presumed to be co-located with their associated wireless network device 220.

The network device 220a includes a processor 460 and a computer-usable medium 470. The computer-usable medium 470 includes instructions adapted to cause the processor 460 to perform a method in accordance with an embodiment of the invention. The processor 460 may be adapted to store the signal quality information from each of the detected wireless network devices 220 on the computer-usable medium 470 for use in the various embodiments. It is noted that the computer-usable medium 470 may contain more than one type of media. For example, the computer-readable instructions may be stored on a nonvolatile EEPROM memory device while the signal quality information is stored on a volatile DRAM memory device. Alternatively, one type of media may serve both storage functions. For example, the computer-readable instructions and the signal information may both be stored on non-removable magnetic disk storage drive. More than one network device of the wireless network 200 may be adapted to perform the methods described herein.

### CONCLUSION

Methods and apparatus for identifying and prioritizing wireless network devices have been described herein for selectively establishing communications based on the prioritization. Signal strength in a wireless network is indicative of a distance between a transmitting device and a receiving device. The strongest signal can be presumed to be emanating from the nearest device. Other signal qualities can be indicative of a presumed quality of service. By combining signal quality information with supplemental information concerning the devices, the various embodiments facilitate identifying those devices that match some selection criteria and prioritizing those matching devices based on the signal quality information. An example is to identify the wireless network device having desired characteristics that is nearest a network user.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any such adaptations or variations of the invention. It is manifestly intended that this invention be limited only by the following claims and equivalents thereof.

What is claimed is:

1. A method of identifying and prioritizing wireless network devices, the method comprising:
detecting a signal from one or more wireless network devices, wherein each signal has at least one signal quality;
identifying each of the detected wireless network devices that match a selection criteria;
associating the at least one signal quality with its respective wireless network device for each wireless network device that matches the selection criteria; and
prioritizing the wireless network devices that match the selection criteria based on their associated at least one signal quality.

2. The method of claim 1, wherein detecting a signal from one or more wireless network devices further comprises broadcasting a request from a reference network device and detecting a response from the one or more wireless network devices.

3. The method of claim 1, wherein the at least one signal quality includes a signal quality selected from the group consisting of a signal strength, a signal noise and a signal-to-noise ratio.

4. The method of claim 1, wherein identifying each of the detected wireless network devices that match a selection criteria comprises at least one selection criterion selected from the group consisting of device type, device name, device features, device capabilities, device status, past device performance, available consumables, transaction costs and device permissions.

5. The method of claim 1, wherein identifying each of the detected wireless network devices that match a selection criteria further comprises:
generating a data structure comprising supplemental information associated with the detected wireless network devices; and
searching the supplemental information to identify those detected wireless network devices that match the selection criteria.

6. The method of claim 5, wherein associating the at least one signal quality with its respective wireless network device for each wireless network device that matches the selection criteria further comprises associating each at least one signal quality with its respective wireless network device in the data structure prior to searching the supplemental information to identify those detected wireless network devices that match the selection criteria.

7. The method of claim 1, wherein prioritizing the wireless network devices that match the selection criteria based on their associated at least one signal quality further comprises prioritizing the wireless network devices using a first sort order based on a first signal quality and using a second sort order based on a second signal quality.

8. The method of claim 1, wherein prioritizing the wireless network devices that match the selection criteria based on their associated at least one signal quality further comprises prioritizing the wireless network devices that match the selection criteria based on a signal strength of the received signal such that the wireless network device associated with the highest signal strength receives the highest priority.

9. The method of claim 1, further comprising:
establishing communication with the wireless network device that matches the selection criteria and has the highest priority.

10. The method of claim 1, further comprising:
providing a list of the prioritized wireless network devices that match the selection criteria to a user; and
establishing communication with a wireless network device selected from the prioritized list by the user.

11. The method of claim 10, further comprising:
highlighting a portion of the list of prioritized wireless network devices based on a signal quality of the detected signals.

12. A method of identifying and prioritizing wireless network devices, the method comprising:
for one or more wireless network devices:
detecting a wireless network device, wherein the wireless network device transmits a signal having a first signal quality;
querying the wireless network device to determine whether it is of a desired type;
querying the wireless network device to determine whether is has a desired status; and
associating the first signal quality with the wireless network device when it is of the desired type and it has the desired status;
generating a list of wireless network devices that are of the desired type and have the desired status; and
prioritizing the list of wireless network devices based at least on their associated first signal quality.

13. The method of claim 12, wherein the first signal quality is indicative of a relative distance to the transmitting device or a presumed quality of service available from the transmitting device.

14. The method of claim 12, wherein the signal transmitted from each wireless network device further has at least one additional signal quality.

15. The method of claim 12, further comprising:
establishing communications with the wireless network device of the prioritized list of wireless network devices that has the highest priority.

16. The method of claim 12, further comprising:
providing the prioritized list of wireless network devices to a user; and
in response to a user selection of one of the wireless network devices of the prioritized list of wireless network devices, establishing communications with the selected wireless network device.

17. The method of claim 16, wherein a portion of the prioritized list of wireless network devices is highlighted based on a second signal quality of the transmitted signals.

18. A computer-usable medium having computer-readable instructions stored thereon capable of causing a processor to perform a method, the method comprising:
receiving a signal from a transmitting wireless network device, wherein the signal has at least one signal quality;
obtaining supplemental information from the wireless network device;
associating the at least one signal quality with the wireless network device and its supplemental information;
comparing the supplemental information with a selection criteria to determine whether the wireless network device matches the selection criteria; and
if the wireless network device matches the selection criteria, prioritizing the wireless network device against other wireless network devices matching the selection criteria, wherein the prioritization is based on the at least one signal quality.

19. The method of claim 18, wherein the at least one signal quality comprises a signal strength and wherein the method further comprises:
prioritizing the wireless network devices based on signal strength; and
establishing communications with the wireless network device having the highest signal strength.

20. The method of claim 19, further comprising:
attenuating each received signal if at least one of the received signals is saturated.
